(19) United States
(12) Patent Application Publication
(10) Pub. No.: US 2026/0230979 A1
(43) Pub. Date: Aug. 6, 2026

(54) NES-RELATED LOAD BALANCING

(71) Applicant: Telefonaktiebolaget LM Ericsson (PUBL), Stockholm (SE)

(72) Inventors: Helka-Liina MÄÄTTÄNEN, Espoo (FI); Ali NADER, MALMÖ (SE); Sina MALEKI, MALMÖ (SE)

(21) Appl. No.: 19/151,650

(22) PCT Filed: Feb. 15, 2024
(86) PCT No.: PCT/EP2024/053913

§ 371 Date: Jul. 29, 2025

Related U.S. Application Data
(60) Provisional application No. 63/485,331, filed on Feb. 16, 2023.

(51) Int. Cl. H04W 36/16; H04W 52/02

(52) U.S. Cl. CPC H04W 36/165; H04W 52/0206

(57) ABSTRACT

NES-Related Load Balancing There is provided a method performed by a user equipment, UE. The method comprises obtaining Network Energy Saving, NES, information that indicates information about a NES mode of a candidate target cell for a mobility process. There is further provided a method performed by a network node. The method comprises providing, to a UE, NES information that indicates information about a NES mode of a candidate cell for a mobility process. There is further provided a UE and a network node.

### TECHNICAL FIELD

Embodiments of the present disclosure are directed to methods in a User Equipment, UE, and methods in a network node of a communications network. Further embodiments are directed to a UE and a network node respectively.

### BACKGROUND

### NW Energy Consumption

Energy consumption is a considerable challenge of Fifth Generation (5G) systems today where a major contributor to the energy consumption is the radio unit of Radio Access Network (RAN) system. The network power consumption for New Radio (NR) is said to be less compared to Long Term Evolution (LTE) because of its lean design, i.e., no Cell-Specific Reference Signal (CRS) and the Synchronization Signal Block (SSB) periodicity is by default 20 milliseconds (ms). However, NR in the current implementation might consume more energy compared to LTE, partly due to higher BWs, shorter TTIs and massive number of antennas. This is still evident even at times when cells and beams are lightly loaded or serve no traffic or no users at all. To enable an energy efficient network, Third Generation Partnership Project (3GPP) initiated a Study Item (SI) on Network energy savings in NR, which was concluded with the outcome captured in TR 38.864 (TR 38.864, Study on network energy savings for NR (Release 18) version i00).

Following the SI phase, a new Work Item (WI) on network energy savings for NR was approved at RAN #98. The WI aims to specify the following enhancements:
1. Specify SSB-less Secondary Cell (SCell) operation for inter-band Carrier Aggregation (CA) for frequency range 1 (FR1) and co-located cells, if found feasible by RAN4 study, where a UE measures SSB transmitted on Primary Cell (PCell) or another SCell for an SCell's time/frequency synchronization (including downlink Automatic Gain Control (AGC)), and Layer 1/Layer 2 (L1/L3) measurements, including potential enhancement on SCell activation procedures if necessary.
2. Specify enhancement on cell Discontinuous Transmission/Discontinuous Reception (DTX/DRX) mechanism including the alignment of cell DTX/DRX and User Equipment (UE) DRX in RRC_CONNECTED mode, and inter-node information exchange on cell DTX/DRX.
   Note: No change for SSB transmission due to cell DTX/DRX.
   Note: The impact to IDLE/INACTIVE UEs due to the above enhancement should be avoided.
3. Specify the following techniques in spatial and power domains
   Specify necessary enhancements on CSI and beam management related procedures including measurement and report, and signaling to enable efficient adaptation of spatial elements (e.g. antenna ports, active transceiver chains).
   Specify necessary enhancements on CSI related procedures including measurement and report, and signaling to enable efficient adaptation of power offset values between Physical Downlink Shared Channel (PDSCH) and Channel State Information Reference Signal (CSI-RS).
   Note: Above objectives are only for UE specific channels/signals
   Note: Legacy UE CSI/CSI-RS capabilities applies when considering total number of CSI reports and requirements
4. Specify mechanism(s) to prevent legacy UEs camping on cells adopting the Rel-18 NES techniques, if necessary.
5. Specify Conditional Handover (CHO) procedure enhancement(s) in case source/target cell is in NES mode.
6. Specify inter-node beam activation and enhancements on restricting paging in a limited area.
7. Specify the corresponding Radio Resource Management Radio Frequency (RRM/RF) core requirements, if necessary, for the above features [RAN4]

### Mobility in RRC_IDLE and RRC_INACTIVE State in NR-Cell Selection and Cell Reselection in NR

Cell selection is the process performed by a UE for selecting a cell to camp on when the UE does not already camp on a cell. Cell reselection is the corresponding process when the UE is already camping on a cell, i.e., the process of finding a better (e.g., more reliable) cell to camp on than the current serving (camping) cell and start camping on that cell instead.

The phrase “camping on a cell” means that the UE is synchronized with the cell's downlink transmissions, ensures that up to date system information (that is relevant for the UE's operation) for the cell is stored in the UE, monitors the physical downlink control channel (PDCCH) for paging transmissions and monitors the channel quality to assess the cell's suitability as a serving cell in relation to other cells to potentially camp on (by performing cell reselection). A UE camps on a cell while in the RRC_IDLE and RRC_INACTIVE states. The cell a UE is camping on is also referred to as the UE's serving cell.

### Cell Selection and Cell Reselection in NR are Specified in 3GPP TS 38.304 (Rel-17 v 17.3.0).

### The Cell Selection Criterion

Of central importance in the cell selection (and cell reselection) procedure is the cell selection criterion, S, which is specified as follows in 3GPP TS 38.304:

The cell selection criterion S is fulfilled when:

$$Srxlev > 0 AND Squal > 0$$

$$where :$$

$$Srxlev = {Q}_{rxlevmeas} - ( {Q}_{rxlevmin} + {Q}_{rxlevminoffset} ) - {P}_{compensation} - {Qoffset}_{temp}$$

$$Squal = {Q}_{qualmeas} - ( {Q}_{qualmin} + {Q}_{qualminoffset} ) - {Qoffset}_{temp}$$

where:

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 (dB) |
| Qᵣₓₗₑᵥₘₑₐₛ | Measured cell RX level value (RSRP) |
| Q_{qualmeas} | Measured cell quality value (Received Signal Reference Quality (RSRQ)) |
| Qᵣₓₗₑᵥₘᵢₙ | Minimum required RX level in the cell (dBm). If the UE |
| | supports SUL frequency for this cell, Qrxlevmin is obtained |
| | from q-RxLevMinSUL, if present, in SIB1, SIB2 and SIB4, |
| | additionally, if Q_{rxlevminoffsetcellSUL} is present in SIB3 and SIB4 for |
| | the concerned cell, this cell specific offset is added to the |
| | corresponding Qrxlevmin to achieve the required minimum |
| | RX level in the concerned cell; |
| | else Qrxlevmin is obtained from q-RxLevMin in SIB1, SIB2 |
| | and SIB4, additionally, if Q_{rxlevminoffsetcell} is present in SIB3 and |
| | SIB4 for the concerned cell, this cell specific offset is added to |
| | the corresponding Qrxlevmin to achieve the required minimum |
| | RX level in the concerned cell. |
| Q_{qualmin} | Minimum required quality level in the cell (dB). Additionally, |
| | if Q_{qualminoffsetcell} is signalled for the concerned cell, this cell |
| | specific offset is added to achieve the required minimum |
| | quality level in the concerned cell. |
| Q_{rxlevminoffset} | Offset to the signalled Qᵣₓₗₑᵥₘᵢₙ taken into account in the Srxlev |
| | evaluation as a result of a periodic search for a higher priority |
| | PLMN while camped normally in a VPLMN, as specified in |
| | TS 23.122. |
| Q_{qualminoffset} | Offset to the signalled Q_{qualmin} taken into account in the Squal |
| | evaluation as a result of a periodic search for a higher priority |
| | PLMN while camped normally in a VPLMN, as specified in |
| | TS 23.122. |
| P_{compensation} | For FR1, if the UE supports the additionalPmax in the NR-NS- |
| | PmaxList, if present, in SIB1, SIB2 and SIB4: |
| | max (P_{EMAX1} −P_{PowerClass}, 0) − (min(P_{EMAX2}, P_{PowerClass}) − |
| | min(P_{EMAX1}, P_{PowerClass})) (dB); |
| | else: |
| | max (P_{EMAX1} − P_{PowerClass}, 0) (dB) |
| | For FR2, P_{compensation} is set to 0. |
| P_{EMAX1}, P_{EMAX2} | Maximum TX power level of a UE may use when transmitting |
| | on the uplink in the cell (dBm) defined as P_{EMAX} in TS 38.101. |
| | If UE supports SUL frequency for this cell, P_{EMAX1} and P_{EMAX2} |
| | are obtained from the p-Max for SUL in SIB1 and NR-NS- |
| | PmaxList for SUL respectively in SIB1, SIB2 and SIB4 as |
| | specified in TS 38.331, else P_{EMAX1} and P_{EMAX2} are obtained |
| | from the p-Max and NR-NS-PmaxList respectively in SIB1, |
| | SIB2 and SIB4 for normal UL as specified in TS 38.331. |
| P_{PowerClass} | Maximum RF output power of the UE (dBm) according to the |
| | UE power class as defined in TS 38.101-1. |

Another central concept in the cell selection and cell reselection procedures is a “suitable cell.” In brief, a suitable cell is a cell that fulfills the cell selection criterion and in which the UE can receive normal service.

FIG. 1 below illustrates the states and state transitions for a UE cell selection and cell reselection in RRC_IDLE or RRC_INACTIVE state.

### Cell Selection

There are two variants of cell selection in NR:
Initial cell selection, where the UE has no prior knowledge of which radio frequency channels are NR frequencies, in which case the UE scans all radio frequency channels in the NR bands according to its capabilities to find a suitable cell to select and camp on.
Cell selection by leveraging stored information, where the UE has stored previously acquired information about frequencies and possibly also cell parameters, which it utilizes to streamline the procedure of selection a suitable cell to camp on.

In TS 38.304, these cell selection variants are specified as follows:

Cell selection is performed by one of the following two procedures:
1. Initial cell selection (no prior knowledge of which RF channels are NR frequencies):
   a. The UE shall scan all RF channels in the NR bands according to its capabilities to find a suitable cell.
   b. On each frequency, the UE need only search for the strongest cell, except for operation with shared spectrum channel access where the UE may search for the next strongest cell(s).
   c. Once a suitable cell is found, this cell shall be selected.
2. cell selection by leveraging stored information:
   a. This procedure requires stored information of frequencies and optionally also information on cell parameters from previously received measurement control information elements or from previously detected cells.
   b. Once the UE has found a suitable cell, the UE shall select it.
   c. If no suitable cell is found, the initial cell selection procedure in a) shall be started.

NOTE: Priorities between different frequencies or radio access technologies (RATs) provided to the UE by system information or dedicated signalling are not used in the cell selection process.

### Cell Reselection

Cell reselection involves reselection between cells on the same carrier frequency, between cells on different carrier frequencies as well as between different RATs (on different carrier frequencies).

### Cell Reselection Between Different Carrier Frequencies and RATs

The network can configure priorities that govern how the UE performs cell reselection between carrier frequencies and RATs. The network may further configure threshold-based conditions which must be fulfilled for inter-frequency/RAT cell reselection to take place. The carrier frequency and RAT priorities and the thresholds governing inter-frequency and inter-RAT cell reselection may be configured through the broadcast system information and the carrier frequency and RAT priorities can also be configured through dedicated signaling using the RRCRelease message.

For cell reselection to a higher priority carrier frequency or RAT, it suffices that the concerned cell's quality exceeds a configured threshold. For cell reselection to a lower priority carrier frequency or RAT, the concerned cell's quality has to exceed a configured threshold and the serving cell's quality has to be below another configured threshold. Cell reselection to a cell on a carrier frequency with equal priority, including the current carrier frequency (i.e., intra-frequency cell reselection) is based on a cell ranking procedure, which is described further below.

Cell reselection to a higher priority RAT/carrier frequency has precedence over a lower priority RAT/frequency, if multiple cells of different priorities fulfil the cell reselection criteria. If multiple cells fulfil the cell reselection criteria on the selected (i.e. highest priority) carrier frequency and this carrier frequency is an NR carrier, the UE reselects to the highest ranked of these cells according to the above-mentioned cell ranking procedure. If multiple cells fulfil the cell reselection criteria on the selected (i.e., highest priority) (non-NR) RAT, the UE reselects to one of these cells in accordance with the criteria that apply for that RAT.

If cells on multiple carrier frequencies and/or RATs fulfill the cell reselection criteria, the UE should reselect to a cell on the carrier frequency or RAT with the highest priority (out of the ones for which there are cells meeting the cell reselection criteria). If multiple cells fulfil the cell reselection criteria on this carrier frequency/RAT, the UE uses the above-mentioned cell ranking to select a cell.

### Intra-Frequency Cell Reselection and Inter-Frequency Cell Reselection to Equal Priority Carrier Frequencies

When multiple NR cells with equal priority fulfil the cell reselection criteria, including both intra-frequency cells and inter-frequency cells (where the inter-frequency carrier frequencies have a priority that is equal to the priority of the UE's current carrier frequency), the UE uses a cell ranking procedure to identify the best (highest ranked) cell to reselect to. The cell ranking is performed as follows:

For each cell involved in the cell ranking the UE calculates a ranking value (denoted Rₙ for a neighbor cell and Rₛ for the serving cell) according to the following two formulae (one for the serving cell and one for neighbor cells):

$${R}_{s} = {Q}_{m e a s , s} + {Q}_{h y s t} - {Qoffset}_{t e m p}$$

$${R}_{n} = {Q}_{m e a s , n} - Qoffset - {Qoffset}_{t e m p}$$

where:

| | |
|---|---|
| Qₘₑₐₛ | RSRP measurement quantity used in cell reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell as specified in |
| | 3GPP TS 38.331. |

To determine a cell's RSRP (Qmeas,s for the serving cell, Qmeas,n for a neighbor cell) the UE measures the RSRP of each of the cell's SSBs and calculates the linear average of a set of the resulting RSRP values. The set of SSB RSRP values to base the averaging on is determined by two parameters configured in the system information: An RSRP threshold, absThreshSS-BlocksConsolidation, which the RSRP of an SSB must exceed for the SSB's RSRP value to be part of the average calculation, and an integer parameter, nrofSS-BlocksToAvearge, representing the maximum number of RSRP values to be used in the averaging. That is, the UE calculates the average (in the linear domain) of the up to nrofSS-BlocksToAvearge highest RSRP values exceeding absThreshSS-BlocksConsolidation. If less then nrofSS-BlocksToAvearge RSRP values exceed absThreshSS-BlocksConsolidation, the UE calculates the linear average of the RSRP values that exceed absThreshSS-BlocksConsolidation. If no SSB RSRP value exceeds absThreshSS-BlocksConsolidation, the UE determines the cell RSRP as the RSRP of the SSB with the highest RSRP in the cell.

Both nrofSS-BlocksToAverage and absThreshSS-BlocksConsolidation are optional to configure. If any of them is absent, the UE determines the cell RSRP as the RSRP of the SSB with the highest RSRP in the cell.

As one option, the UE reselects to (or remains in) the highest ranked cell, i.e., the one with the highest R (Rₙ or Rₛ) value, according to the above algorithm. That is, if one of the neighbor cells is ranked the highest, the UE reselects to that cell, while if the serving cell gets the highest rank, then the UE remains camping on the current serving cell.

As another option, the network may configure an offset range in relation to the highest calculated R value (Rₙ or Rₛ), denoted rangeToBestCell. With this option, any non-highest ranked cell whose ranking value, Rₙ or Rₛ, closer to the highest R value than rangeToBestCell, are qualified to a second round, where the UE selects the cell to reselect to (or remain camping on, in case the serving cell is selected) based on the number of SSBs each cell has with RSRP values above absThreshSS-BlocksConsolidation. If two or more of these cells have the same number of SSBs with RSRP above absThreshSS-BlocksConsolidation, the UE selects the cell with the highest R value. If rangeToBestCell is configured, but absThreshSS-BlocksConsolidation is not configured, the UE considers that there is one SSB above the threshold for each cell on that frequency.

For any of the above-described conditions for cell reselection to result in a cell reselection, it must persist for a configurable time period (t-reselectionNR for NR or t-reselectionEUTRA for EUTRA, which respectively correspond to the parameters TreselectionNR and TreselectionEUTRA in 3GPP TS 38.304), which is configured in the system information. An additional condition is that no preceding cell reselection has occurred during the last 1 second.

If the cell a UE has selected for reselection is found to be not suitable, the UE will not reselect to that cell and its further behavior is specified in section 5.2.4.4 in 3GPP TS 38.304.

### Limiting Neighbor Cell Measurements and the Frequency of Cell Reselections

The standard has several built-in mechanisms for limiting the amount of neighbor cell measurements a UE needs to perform and the frequency of its cell reselections.

To this end, the UE may choose not to perform intra-frequency measurements, if the serving cell fulfils Srxlev>S_{IntraSearchP} and Squal>S_{IntraSearchQ}, Similarly, if the serving cell fulfils Srxlev>S_{nonIntraSearchP} and Squal>S_{nonIntraSearchQ}, the UE may choose not to perform measurements on NR inter-frequencies or inter-RAT frequency cells of equal or lower priority. However, the UE shall not refrain from measuring on NR inter-frequencies or inter-RAT frequencies with a reselection priority higher than the reselection priority of the current NR frequency.

The cell reselection rules in 3GPP TS 38.304 further limits the maximum frequency of cell reselections to once per second, i.e., according to the specified cell reselection rules a UE must camp on a cell for at least one second before it can reselect to another cell. In addition, a cell reselection condition, in terms of measured neighbor cell quality (and, when applicable, serving cell quality) must be fulfilled during the time period Treselection_{RAT} before it can trigger a cell reselection, where Treselection_{RAT} is configurable in the range 0-7 seconds.

The use of a hysteresis, realized by the configurable Q_{hyst} parameter in the ranking formula for the serving cell (i.e. in the formula Rₛ=Q_{meas,s}+Q_{hyst}−Qoffsetₜₑₘₚ) also serves to reduce the frequency of cell reselections, as it favors remaining in the current serving cell.

Furthermore, 3GPP release 16 of NR includes a feature for the network to configure a UE to be allowed to relax its neighbor cell measurements for cell reselection evaluation when certain conditions are fulfilled that indicate that the need or probability for a cell reselection in the near future is low.

Another feature does not reduce the number or frequency of neighbor cell measurements, but instead reduces the effort a UE spends on a neighbor cell measurement. This is the SSB Measurement Timing Configuration (SMTC), by which the network can configure a periodic time window per carrier frequency, in which the SSB transmissions that the RRC_IDLE or RRC_INACTIVE UE measures on occurs. For neighbor cell measurements in RRC_CONNECTED state, a UE may be configured with more advanced SMTC, including cell specific SMTC.

### SUMMARY

There currently exist certain challenge(s). For example, currently only mechanism to account NES cell or NES mode for a cell for Idle or inactive mobility is to tune the existing system information parameters/thresholds by the source cell.

Certain aspects of the disclosure and their embodiments may provide solutions to these or other challenges. For example, particular embodiments provide systems and methods to perform load balancing according to NES mode or NES type of the cells. Certain embodiments may provide one or more of the following technical advantage(s). For example, particular embodiments enable NES aware load balancing and idle/inactive mode mobility.

The present invention is defined in the independent claims, to which reference is now directed.

There is provided a method performed by a user equipment, UE. The method comprises obtaining Network Energy Saving, NES, information that indicates information about a NES mode of a candidate target cell for a mobility process. The mobility process may comprise an idle or inactive mode mobility process. The candidate target cell may also be referred to as a candidate cell.

The NES mode may be indicated in a System Information Block, SIB.

In some embodiments, the NES mode may be indicated in a System Information Block, SIB, of the candidate target cell.

In some embodiments, the NES information may comprise information about one or more neighboring cells. The candidate target cell may be one of the one or more neighboring cells.

The NES mode may be indicated by a binary indication.

The NES information may comprise one or more NES techniques supported during the NES mode of the candidate target cell. The NES mode may be indicated by a set of associated parameters, a bitmap, or a mask. The one or more NES techniques may comprise at least one of: a gNB on/off; a gNB operating in cell-discontinuous transmission (DTX); a gNB operating in cell-discontinuous reception (DRX); a gNB operating with reduced output power; a gNB operating with reduced number of antennas; and a synchronization signal block (SSB) less cell.

The NES information may comprise information about a neighbor cell, such that a supported NES feature of the candidate target cell is indicated by a serving cell.

The method may further comprise, wherein the UE is in idle or inactive mode, obtaining information about a priority of the candidate target cell, the priority indicating whether the candidate target cell invites or repels UEs, wherein the priority is indicated in a message received by the UE.

The priority may comprise a set of priorities based on a set of characteristics comprising, at least one of: a cell type, a UE type, and a service level.

The NES information may further indicate a set of NES modes of a set of candidate target cells for a mobility process. The method may further comprise selecting a particular candidate target cell from among the set of candidate target cells based at least on a set of priorities associated with the set of candidate target cells, wherein the set of priorities are indicated in a message received by the UE.

In some embodiments, the method may further comprise reselecting from the candidate target cell to another cell if one or more NES modes are turned off in the candidate target cell.

The method may further comprise reselecting the candidate target cell based on the NES information. In particular, the method may comprise reselecting the candidate target cell, whilst the UE is in inactive or idle mode. The method may further comprise camping on the reselected candidate target cell.

There is further provided a method performed by a network node. The method comprises providing, to a User Equipment, UE, Network Energy Saving, NES, information that indicates information about a NES mode of a candidate cell for a mobility process. The mobility process may comprise a UE idle/inactive mode mobility process.

The NES mode may be indicated in a System Information Block, SIB, of the candidate target cell.

The NES information may comprise information about one or more neighboring cells.

The NES mode may be indicated by a binary indication.

The NES information comprises one or more NES techniques supported during the NES mode of the candidate target cell. The NES mode may be indicated by a set of associated parameters, a bitmap, or a mask. The one or more NES techniques may comprise at least one of: a gNB on/off; a gNB operating in cell-discontinuous transmission (DTX); a gNB operating in cell-discontinuous reception (DRX); a gNB operating with reduced output power; a gNB operating with reduced number of antennas; and a synchronization signal block (SSB) less cell.

The NES information may comprise information about a neighbor cell, such that a supported NES feature of the candidate target cell is indicated by a serving cell.

The method may further comprise, wherein the UE is in idle or inactive mode, providing information about a priority of the candidate target cell, the priority indicating whether the candidate target cell invites or repels UEs, wherein the priority is indicated in a message provided to the UE.

The priority may comprise a set of priorities based on a set of characteristics comprising, at least one of: a cell type, a UE type, and a service level.

The NES information may further indicate a set of NES modes of a set of candidate target cells for a mobility process. The method may further comprise providing a set of priorities associated with the set of candidate target cells, wherein the set of priorities are indicated in a message received by the UE.

There is further provided a user equipment, UE. The UE comprises processing circuitry configured to perform any of the methods described above as performed by a UE. The UE further comprises power supply circuitry configured to supply power to the processing circuitry.

There is further provided a network node. The network node comprises processing circuitry configured to perform any of the methods described above as performed by a network node. The network node further comprises power supply circuitry configured to supply power to the processing circuitry.

### BRIEF DESCRIPTION OF THE DRAWINGS

Some of the embodiments contemplated herein will now be described more fully with reference to the accompanying drawings. Embodiments are provided by way of example to convey the scope of the subject matter to those skilled in the art.

FIG. 1 illustrates a procedure for RRC_IDLE and RRC_INACTIVE Cell Selection and Reselection;

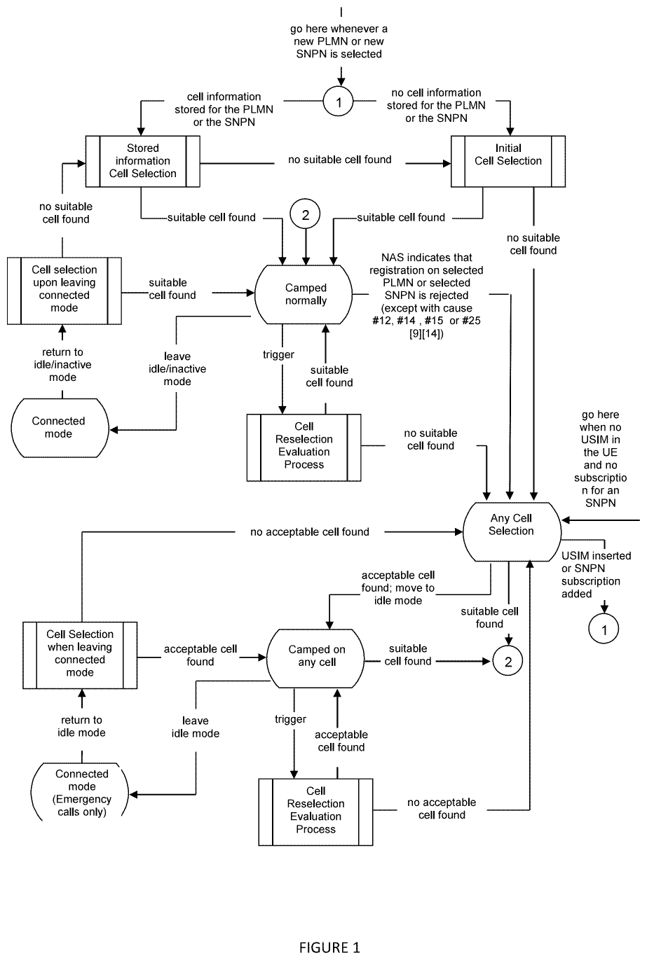

FIG. 2 illustrates an example of a communications system in accordance with some embodiments;

FIG. 3 shows a UE in accordance with some embodiments;

FIG. 4 shows a network node in accordance with some embodiments;

FIG. 5 is a block diagram illustrating a virtualization environment in which functions implemented by some embodiments may be virtualized;

FIG. 6 is a flow chart showing a method in a UE according to an embodiment; and

FIG. 7 is a flow chart showing a method in a network node according to an embodiment.

### DETAILED DESCRIPTION

Note: Unless otherwise stated explicitly the methods proposed below concern both fixed and moving cells, service and feeder link switches.

Note: Unless otherwise stated explicitly, the terms cell and beam are used interchangeably in this document.

Note: The terms “wireless terminal”, “User Equipment”, “UE”, “wireless device” and “device” are used interchangeably in this document.

In some embodiments, the network energy saving (NES) mode may be visible in system information (SI) of the cell supporting and/or using NES technique, for example, in ServingcellConfigCommon/ServingcellConfigCommonSIB, a UE receiving the Conditional Handover (CHO) would know about the NES mode of a candidate target cell by reading the system information related to the target cell. The NES information may, for example, reside in SIB1 of a target cell. Alternatively, or additionally, other SIBs (including newly introduced) may be used for the same purpose.

In some embodiments, the NES information may be shared about neighbor cells, which may be implemented, for example, in SIB2, SIB4, or a newly defined SIB.

In some embodiments, the associated SIB may be configured to be on-demand, or area based. The SIB may be exempt from SI update regular procedure, i.e., if the SIB is updated, the UEs become aware that the SIB is updated so that they need to reacquire it themselves without receiving a SI update indication.

In some embodiments, the NES mode may be a binary indication, such as ON/OFF. In some embodiments, one or more specific NES techniques that are supported/used during NES mode may be indicated (e.g., via a set of associated parameters, or a bitmap/mask). Examples of such NES techniques may include complete gNB on/off, gNB operating in Cell-DTX/DRX respectively, gNB operating with reduced output power, gNB operating with reduced number of antennas, SSB less cell, e.g., Scell, WUS enabled gNB, on-demand SSB/SIB1 cells, etc.

In some embodiments, there may be a separation between what the gNB supports (might use during NES mode) and what the gNB is currently using. For example, the gNB may indicate that it supports Cell DTX/DRX, but not currently be in Cell DTX/DRX. Thus, in some embodiments, the UE may be provided information about a neighbor cell in a partial way such that only the supporting NES feature of target cell is provided through the serving cell. For example, when the NES information is provided in a neighbor cell SIB (such as, SIB2 or SIB4), the full information including the current NES technique currently used may be derived from the target cell via system information of that target cell instead. In the same or another example, the NES information may be derived via random access procedure towards the target cell. Note target cell here refers to reselected cell.

In some embodiments, a priority may be set in ServingCellConfigCommon/ServingCellConfigCommonSIB to inform both idle mode UEs and inactive UES whether that cell invites or repels more UEs. Note that although in some embodiments, load balancing for idle and inactive UEs as the priority may be broadcasted, it is understood that in other embodiments, connected mode UEs may apply the priority. This operation may be done via the conditional handover configuration where the priority of the candidate target cell may be shared in the RRCReconfiguration message which may include the SIBs carrying this information.

For example, if a NES cell has low load, it may be desired for the cell to allow some more UEs to move to the cell, whereas if NES cell has high load, the cell may prefer UEs to prioritize another cell. It shall be noted that the low/high load scenario is only an example. The target gNB may have other reasons for not wanting to invite more UEs that that related to the cell load. For example, the gNB may want to prioritize energy saving and maintain low load and therefore not invite more UEs. Regardless of the reason, the target cell may advertise a high priority value when it is desired to allow more UEs to connect to the cell compared to a low value when the cell wants to repel UEs. In some examples, the priority may be a single value. In the same or other examples, the priority may be a set of priorities which are set on cell-, UE type-, service level, or the like. Alternatively or additionally, there may be a single priority but certain important UE types, or UEs associated with certain services (e.g., 5QIs) that are allowed to ignore the repelling type of priorities. Another option is that the priority is scaled according to the UE- or service types. Based on the priority, a UE with multiple target cell options may pick the cell with higher priority (e.g., more inviting) candidate target cell.

In some embodiments, the priorities may not be absolute (meaning that a higher priority may not always be chosen). For example, probability rates of the candidate target cells may be used so that the UE chooses as its target cell based on the probability rates. For example, if two target cells have good enough quality for potential CHO, one has a probability rate set to 9, the other 1, then the UE uses a weighted probability function such that for example 90% of the time the first cell is chosen as a target.

In some embodiments, the priorities may be inbuilt in the Qoffsets as RSRP offsets. The to be applied offset may depend on whether the NES cell is in NES mode and further on which level or type of NES mode. This may vary e.g., based on the intended sleep portion of the cell. This information may also be broadcasted so UE may deduce the correct offset to be applied.

In some embodiments, one or more of the NES techniques that are to be used by a cell may be associated with a time schedule. For example, the target cell may advertise in system information that the gNB is going to turn off its radio at a certain time expressed by e.g., frame number, or actual universal time coordinated (UTC) time, or the like. The information may be short- and/or long scale, e.g., cover seconds from now or provide information about daily/weekly type of schedule.

In some embodiments, the NES mode and associated information (e.g., support, time schedule, etc.) mentioned above may be more granular than that of cell level. The information may instead be provided per part of the cell such as per beam (e.g., per SSB).

In some embodiments, a UE may reselect from a first cell to a second cell, if one or more specific NES modes are turned off in that cell, e.g., antennas are not reduced, power is not adapted, cell DTX/DRX is turned off or deactivated or de-configured, SSBs are transmitted over Scells, on-demand SSB/SIB1 is not configured or deactivated, etc. As such, the UE may receive an implicit or explicit indication that a specific NES mode or technique is not applied, or its impact is reduced and thus has to reselect. For example, if the number of antenna ports or elements is more than a first threshold, the UE may handover to a second cell possibly with lower number of antenna ports and elements.

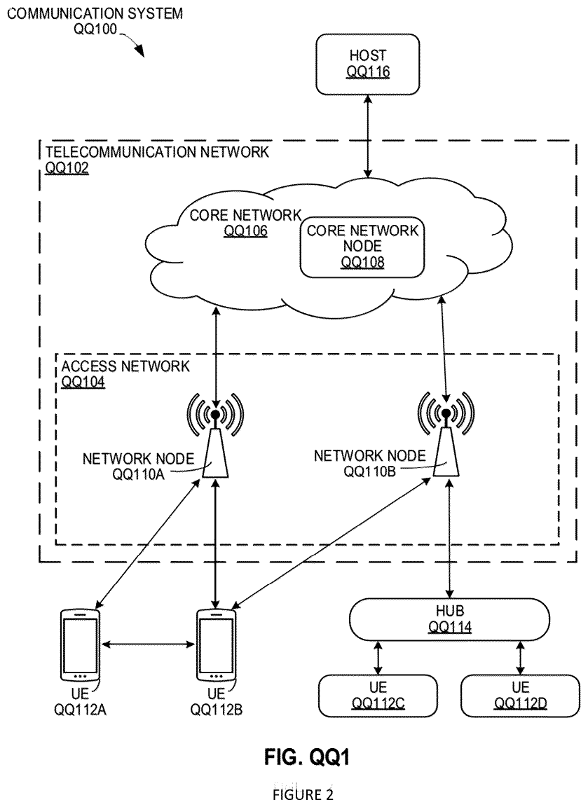

FIG. 2 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. QQ1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

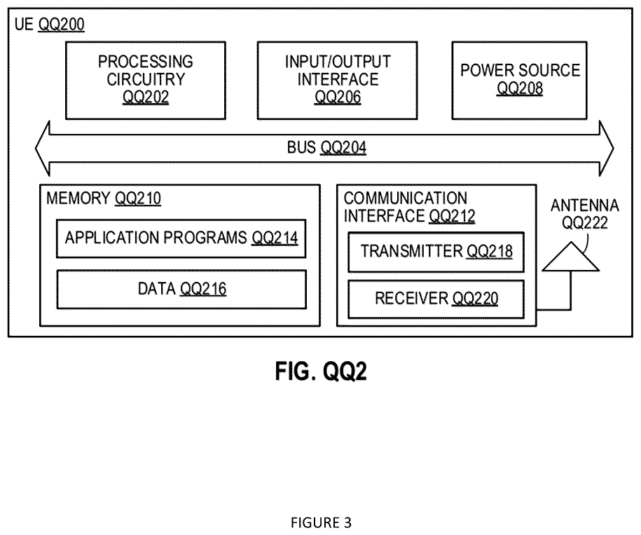

FIG. 3 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

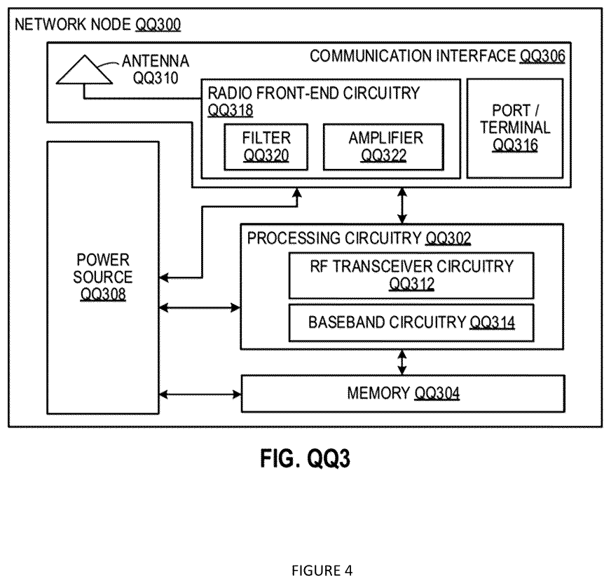

FIG. 4 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

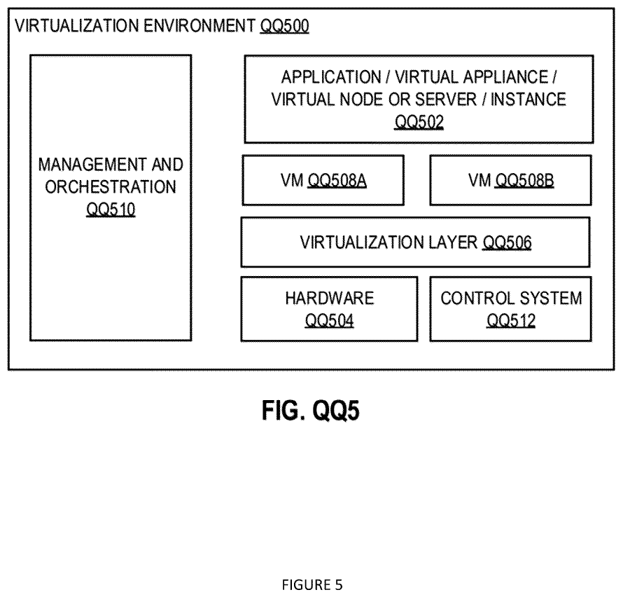

FIG. 5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

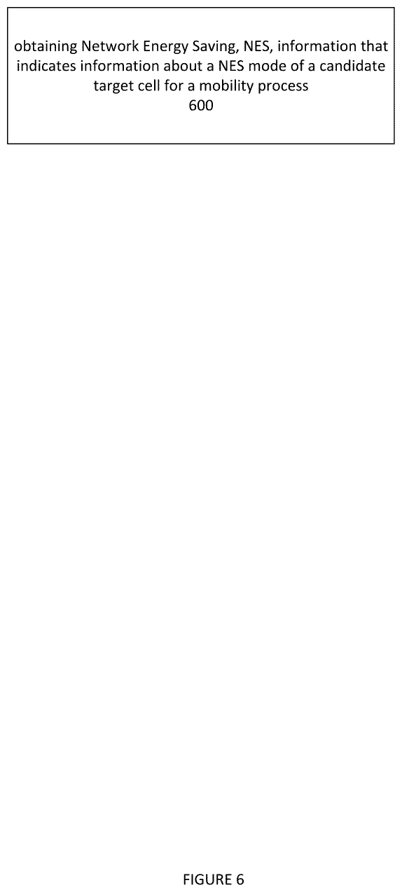

FIG. 6 is a flowchart illustrating an example method in a User Equipment, UE, according to certain embodiments. In particular embodiments, the method of FIG. 6 may be performed by UE 200 described with respect to FIG. 3.

The method may comprise, at step 600, the UE (e.g., UE 200) obtaining Network Energy Saving, NES, information that indicates information about a NES mode of a candidate target cell for a mobility process. The mobility process may comprise a UE idle or inactive mode mobility process.

The NES mode may be indicated in a System Information Block, SIB, for example received from a serving cell.

In some embodiments, the NES mode may be indicated in a System Information Block, SIB, of the candidate target cell.

In some embodiments, the NES information may comprise information about one or more neighboring cells. In this case, the NES information may be included in a System Information Block, SIB, of the serving cell.

The NES mode may be indicated by a binary indication.

The NES information may comprise one or more NES techniques supported during the NES mode of the candidate target cell. The NES mode may be indicated by a set of associated parameters, a bitmap, or a mask. The one or more NES techniques may comprise at least one of: a gNB on/off; a gNB operating in cell-discontinuous transmission (DTX); a gNB operating in cell-discontinuous reception (DRX); a gNB operating with reduced output power; a gNB operating with reduced number of antennas; and a synchronization signal block (SSB) less cell.

The NES information may comprise information about a neighbor cell, such that a supported NES feature of the candidate target cell is indicated by a serving cell.

The method may further comprise, when the UE is in idle or inactive mode, obtaining information about a priority of the candidate target cell, the priority indicating whether the candidate target cell invites or repels UEs, wherein the priority is indicated in a message received by the UE.

The priority may comprise a set of priorities based on a set of characteristics comprising, at least one of: a cell type, a UE type, and a service level.

The NES information may further indicate a set of NES modes of a set of candidate target cells for a mobility process. The method may further comprise selecting a particular candidate target cell from among the set of candidate target cells based at least on a set of priorities associated with the set of candidate target cells, wherein the set of priorities are indicated in a message received by the UE.

The method may further comprise selecting or reselecting the candidate target cell based on the NES information. For example, the method may comprise selecting or reselecting the candidate target cell, whilst the UE is in idle or inactive mode. The method may further comprise camping on the candidate target cell.

In some embodiments, the method may further comprise reselecting from the candidate target cell to another cell if one or more NES modes are turned off in the candidate target cell.

Modifications, additions or omissions may be made to the method of FIG. 6. Any one or more steps in the method may be performed in parallel or in any suitable order.

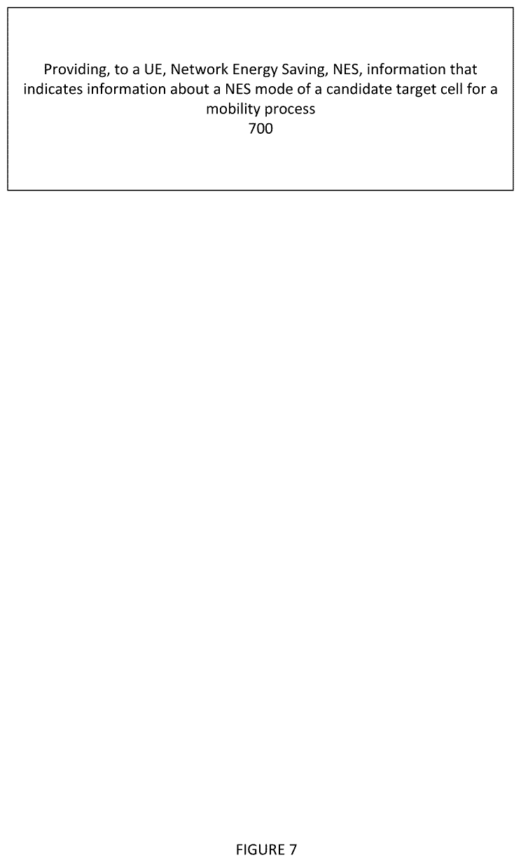

FIG. 7 is a flowchart illustrating an example method in a network node, according to certain embodiments. In particular embodiments, the method of FIG. 7 may be performed by network node 300 described with respect to FIG. 4.

The method may comprise, at step 700, the network node (e.g., network node 300) providing, to a User Equipment, UE, Network Energy Saving, NES, information that indicates information about a NES mode of a candidate target cell for a mobility process. The mobility process may comprise UE idle or inactive mode mobility.

The NES information may be transmitted in a System Information Block, SIB.

For example, the NES mode may be indicated in a System Information Block, SIB, of the candidate target cell.

The NES information may comprise information about one or more neighboring cells.

The NES mode may be indicated by a binary indication.

The NES information may comprise one or more NES techniques supported during the NES mode of the candidate target cell. The NES mode may be indicated by a set of associated parameters, a bitmap, or a mask. The one or more NES techniques may comprise at least one of: a gNB on/off; a gNB operating in cell-discontinuous transmission (DTX); a gNB operating in cell-discontinuous reception (DRX); a gNB operating with reduced output power; a gNB operating with reduced number of antennas; and a synchronization signal block (SSB) less cell.

The NES information may comprise information about a neighbor cell, such that a supported NES feature of the candidate target cell is indicated by a serving cell. The network node may be a network node of the serving cell.

The method may further comprise, when the UE is in idle or inactive mode, providing information about a priority of the candidate target cell, the priority indicating whether the candidate target cell invites or repels UEs, wherein the priority is indicated in a message provided to the UE.

The priority may comprise a set of priorities based on a set of characteristics comprising, at least one of: a cell type, a UE type, and a service level.

The NES information may further indicate a set of NES modes of a set of candidate target cells for a mobility process. The method may further comprise providing a set of priorities associated with the set of candidate target cells, wherein the set of priorities are indicated in a message received by the UE.

Modifications, additions, or omissions may be made to the method of FIG. 7. Additionally, one or more steps in the method of FIG. 7 may be performed in parallel or in any suitable order.

Thus, embodiments may have the advantage of enabling NES aware load balancing and idle/inactive mode mobility. For example, embodiments may advantageously enable load balancing for NES cells in a mobile network.

Some embodiments may be described by the following clauses:

### EMBODIMENTS

### Group A Embodiments

1. A method performed by a user equipment (UE) for load balancing for network energy saving (NES) cells in mobile networks, the method comprising:
   obtaining an NES information that indicates information about an NES mode of a candidate target cell for a handover process.
2. The method of the previous embodiment, wherein NES mode is indicated in a system information block (SIB) of a candidate target cell that uses the NES mode.
3. The method of any one of the previous embodiments, wherein the NES information comprises information about one or more neighboring cells.
4. The method of any one of the previous embodiments, wherein the NES mode is indicated by a binary indication.
5. The method of any one of the previous embodiments, wherein:
   the NES information comprises one or more NES techniques supported during the NES mode of the candidate target cell; and
   the NES mode is indicated by a set of associated parameters, a bitmap, or a mask;
   the one or more NES techniques comprise at least one of:
      a gNB on/off;
      a gNB operating in cell-discontinuous transmission (DTX);
      a gNB operating in cell-discontinuous reception (DRX);
      a gNB operating with reduced output power;
      a gNB operating with reduced number of antennas; and
      a synchronization signal block (SSB) less cell.
6. The method of any one of the previous embodiments, wherein the NES information comprises information about a neighbor cell, such that a supporting NES feature of the candidate target cell is provided a serving cell.
7. The method of any one of the previous embodiments, wherein:
   the UE is in idle or inactive mode; and
   the method further comprises obtaining information about whether the candidate target cell invites or repels UEs, wherein a priority is set in a message to inform the UE in idle or inactive mode whether the candidate target cell invites or repels the UEs.
8. The method of any one of the previous embodiments, wherein a set of priorities are set on a set of characteristics comprising a cell type, a UE type, or a service level.
9. The method of any of the previous embodiments, wherein:
   the NES information further indicates a set of NES modes of a set of candidate target cells for a handover process;
   the method further comprises:
      selecting a particular candidate target cell from among the set of candidate target cells based at least on a set of priorities associated with the set of candidate target cells, wherein the set of priorities are provided in a message to the UE.
10. The method of any of the previous embodiments, wherein selecting a particular candidate target cell comprises:
   determining a set of probability rates for accepting new UEs of the set of candidate target cells;
   determining that the particular candidate target cell has a higher probability rate compared to other candidate target cells.
10. The method of any of the previous embodiments, further comprising reselecting from the candidate target cell to another cell if one or more NES modes are turned off in the candidate target cell.
11. A method performed by a wireless device, the method comprising:
   any of the wireless device steps, features, or functions described above, either alone or in combination with other steps, features, or functions described above.
12. The method of the previous embodiments, further comprising one or more additional wireless device steps, features or functions described above.
13. The method of any of the previous embodiments, further comprising:
   providing user data; and
   forwarding the user data to a host via the transmission to the network node.

### Group B Embodiments

14. A method performed by a network node for load balancing for Network Energy Saving (NES) cells in mobile networks, the method comprising:
providing an NES information that indicates information about an NES mode of a candidate cell for a handover process.
15. The method of any of the previous embodiments, further comprising providing information about whether the candidate target cell invites or repels UEs, wherein a priority is set in a message to inform the UE in idle or inactive mode whether the candidate target cell invites or repels the UEs.
16. The method of any of the previous embodiments, further comprising:
   providing the NES information that indicates a set of NES modes of a set of candidate target cells for a handover process; and
   providing a set of priorities of the set of candidate target cells, wherein the set of priorities are set on a set of characteristics comprising a cell type, a UE type, or a service level.
18. A method performed by a network node, the method comprising:
   any of the steps, features, or functions described above with respect to network node, either alone or in combination with other steps, features, or functions described above.
19. The method of the previous embodiments, further comprising one or more additional network node steps, features or functions described above.
20. The method of any of the previous embodiments, further comprising:
   obtaining user data; and
   forwarding the user data to a host or a user equipment.

### Group C Embodiments

21. A user equipment for load balancing for network energy saving (NES) cells in mobile networks, comprising:
   processing circuitry configured to perform any of the steps of any of the Group A embodiments; and
   power supply circuitry configured to supply power to the processing circuitry.
22. A network node for load balancing for network energy saving (NES) cells in mobile networks, the network node comprising:
   processing circuitry configured to perform any of the steps of any of the Group B embodiments;
   power supply circuitry configured to supply power to the processing circuitry.
23. A user equipment (UE) for load balancing for network energy saving (NES) cells in mobile networks, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.

1.-24. (canceled)

25. A method performed by a user equipment, UE, the method comprising:
obtaining Network Energy Saving, NES, information that indicates information about a NES mode of a candidate target cell for a mobility process.

26. The method of claim 25, wherein the NES mode is indicated in a System Information block, SIB, of the candidate target cell.

27. The method of claim 25, wherein the NES information comprises information about one or more neighboring cells.

28. The method of claim 25, wherein the NES mode is indicated by a binary indication.

29. The method of claim 25, wherein:
the NES information comprises one or more NES techniques supported during the NES mode of the candidate target cell;
the NES mode is indicated by a set of associated parameters, a bitmap, or a mask; and
the one or more NES techniques comprise at least one of:
a gNB on/off;
a gNB operating in cell-discontinuous transmission (DTX);
a gNB operating in cell-discontinuous reception (DRX);
a gNB operating with reduced output power;
a gNB operating with reduced number of antennas; and
a synchronization signal block (SSB) less cell.

30. The method of claim 27, wherein the NES information comprises information about a neighbor cell, such that a supported NES feature of the candidate target cell is indicated by a serving cell.

31. The method of claim 25, wherein:
the UE is in idle or inactive mode; and
the method further comprises obtaining information about a priority of the candidate target cell, the priority indicating whether the candidate target cell invites or repels UEs, wherein the priority is indicated in a message received by the UE.

32. The method of claim 31, wherein the priority comprises a set of priorities based on a set of characteristics comprising, at least one of: a cell type, a UE type, and a service level.

33. The method of claim 25, wherein:
the NES information further indicates a set of NES modes of a set of candidate target cells for a mobility process;
the method further comprises:
selecting a particular candidate target cell from among the set of candidate target cells based at least on a set of priorities associated with the set of candidate target cells, wherein the set of priorities are indicated in a message received by the UE.

34. The method of claim 25, further comprising reselecting from the candidate target cell to another cell if one or more NES modes are turned off in the candidate target cell.

35. The method of claim 25, further comprising reselecting the candidate target cell based on the NES information.

36. The method of claim 25, wherein the UE is in idle or inactive mode.

37. A method performed by a network node, the method comprising:
providing, to a User Equipment, UE, Network Energy Saving, NES, information that indicates information about a NES mode of a candidate target cell for a mobility process.

38. The method of claim 37, wherein the NES information comprises information about one or more neighboring cells.

39. The method of claim 37, wherein the NES mode is indicated by a binary indication.

40. The method of claim 37, wherein:
the NES information comprises one or more NES techniques supported during the NES mode of the candidate target cell;
the NES mode is indicated by a set of associated parameters, a bitmap, or a mask; and
the one or more NES techniques comprise at least one of:
a gNB on/off;
a gNB operating in cell-discontinuous transmission (DTX);
a gNB operating in cell-discontinuous reception (DRX);
a gNB operating with reduced output power;
a gNB operating with reduced number of antennas; and
a synchronization signal block (SSB) less cell.

41. The method of claim 38, wherein the NES information comprises information about a neighbor cell, such that a supported NES feature of the candidate target cell is indicated by a serving cell.

42. A user equipment, comprising:
processing circuitry configured to perform any of the steps of claim 25; and
power supply circuitry configured to supply power to the processing circuitry.

43. A network node comprising:
processing circuitry configured to perform any of the steps of claim 37;
power supply circuitry configured to supply power to the processing circuitry.
